(19) United States
(12) Patent Application Publication
(10) Pub. No.: US 2009/0284326 A1
(43) Pub. Date: Nov. 19, 2009

(54) Balanced hybrid coupler

(76) Inventor: Veljko Napijalo, Dublin (IE)

Correspondence Address: OLIFF & BERRIDGE, PLC, P.O. BOX 320850, ALEXANDRIA, VA, 22320-4850, US

(21) Appl. No.: 12/153,434

(22) Filed: May 19, 2008

(51) Int. Cl. H01P 5/22

(52) U.S. Cl. 333/117

(57) ABSTRACT

A balanced hybrid coupler comprising four identical pairs of quarter wavelength parallel coupled lines, 45A, 45B and 46A, 46B a first input port, a second input port, a first output port and a second output port. The first input port comprising a pair of signal carrying terminals 41A, 41B, the second input port comprising a pair of signal carrying terminals 42A, 42B, the first output port comprising a pair of signal carrying terminals 43A, 43B, and the second output port comprising a pair of signal carrying terminals 44A, 44B. A wiring section 49 connects quarter wavelength coupled line pairs 45A and 45B to quarter wavelength coupled line pairs 46A and 46B, and includes a first balanced connection comprising a pair of connection lines 47A, 47B and a second balanced connection comprising connecting lines 48A, 48B. Connection line 47A connects one of the pair of coupled lines 45A to one of the pair of coupled lines 46A, and connection line 47B connects one of the pair of coupled lines 45B to one of the pair of coupled lines 46B. A twist is added to the balanced connection comprising connecting lines 48A and 48B so that connecting line 48A connects one of the pair of quarter wavelength coupled lines 45A to one of the pair of quarter wavelength coupled lines 46B and so that connecting line 48B connects one of the pair of quarter wavelength coupled lines 45B to one of the pair of quarter wavelength coupled lines 46A. The twist in the balanced connection comprising connecting line 48A and 48B produces the required phase shift of 180°. The balanced 180° hybrid coupler of the present invention is considerably more compact than a balanced 180° hybrid coupler comprising a pair of prior art single-ended hybrid couplers due to the fact that the 180° phase shifting element is realized by adding a twist in the wiring section 49 as opposed to using conventional phase shifting networks.

### FIELD OF THE INVENTION

The present invention relates to a balanced 180 degrees hybrid coupler.

### BACKGROUND

U.S. Pat. No. 7,319,370 discloses a 180 Degrees Hybrid Coupler. Hybrid couplers are four port passive circuits comprising a pair of inputs and a pair of outputs that are widely used in microwave circuits. Ideal hybrid couplers are perfectly matched on all ports; input ports are mutually isolated and output ports are mutually isolated. A common application of a hybrid coupler is for splitting an input signal into two output signals. There are two main types of hybrid coupler: the first being a quadrature hybrid, which provides a 90° relative phase difference between the output signals for a signal incident on either input port; the second being a 180° hybrid, which provides a 180° relative phase difference between the output signals for a signal incident on one input port, and a 0° relative phase difference between the output signals for a signal incident on the other input port. Regarding the signal split ratio of a coupler, the most frequent applications demand equal splitting of the input signal between two identical circuits, so the equal power split hybrid is the most common. In addition to the power splitting applications described above, hybrids can be used for combining signals.

A conventional 180° hybrid coupler (rat race) is shown on FIG. 1. It comprises a micros trip transmission line hexagon having a perimeter of one and a half wavelengths at the operating frequency, with four ports connected along the transmission line hexagon. A signal incident on input port 01, will be split equally between the output ports 03 and 04 and the output signals will be in phase with each other. A signal incident on input port 02, will also be split equally between the output ports 03 and 04; however, the two output signals will be out of phase relative to each other. The input and output ports of the 180° hybrid coupler of FIG. 1 can be interchanged to provide the same functionality, i.e. a signal applied to port 03, will be emitted as two equal signals which are in phase at ports 01 and 02, and a signal applied at the input port 04, will be emitted as two equal signals which are out of phase at ports 01 and 02.

FIG. 2 is a block diagram showing a recently introduced realization of a 180° hybrid coupler comprising two identical pairs of quarter wavelength parallel coupled lines 15, 16, where one of the connections between the coupled lines is made by direct connection 17 and the other is made using a length of transmission line 18 which provides a phase shift of 180° at the centre frequency of the operating band of the hybrid coupler. The coupled line hybrid coupler of FIG. 2 further comprises a first input port 11, a second input port 12, a first output port 13, and a second output port 14. A signal incident on the first input port 11 of the coupled line hybrid coupler of FIG. 2, will be split in phase between the first output port 13 and the second output port 14; on the other hand, a signal incident on the second input port 12, will be split between the first output port 13 and the second output port 14 so that there is a relative phase difference of 180° between the two output signals. For an equal split 180 degrees hybrid coupler, the required coupling ration of quarter wavelength parallel coupled lines 15, 16 is −7.67 dB. In similarity with the rat-race coupler of FIG. 1, the input and output ports of the coupled line hybrid coupler of FIG. 2 can be interchanged to provide the same functionality.

Both of the 180° degree hybrid couplers described above are single-ended, i.e. for each input and output port, there is one signal carrying line which is referenced to ground. However, differential circuits, which comprise a pair of signal carrying lines with equal amplitude and opposite phase, are often preferred over single-ended circuits. For example, differential circuits have been employed in wireless cellular communications handsets and other wireless technologies for many years. The benefits from using differential circuits are lower noise and lower susceptibility to interference.

It is an object of the present invention to provide a balanced coupler which occupies a similar volume to the single ended 180° hybrid coupler of FIG. 2.

### STATEMENT OF INVENTION

Accordingly, the present invention provides a balanced 180° hybrid coupler according to claim 1.

The present invention provides a balanced 180° hybrid coupler operating over a given frequency band, with a particular centre frequency of operation, wherein said hybrid coupler occupies a reduced volume compared to a pair of equivalent single ended hybrid couplers with the same centre frequency of operation, and wherein the operating band of said balanced 180° hybrid coupler is wider than that of the equivalent single-ended hybrid coupler.

### BRIEF DESCRIPTION OF THE DRAWINGS

Embodiments of the invention will now be described, by way of example, with reference to the accompanying drawings, in which:

FIG. 1 shows a conventional rat-race 180° hybrid coupler;

FIG. 2 shows a conventional multilayer coupled-line 180° hybrid coupler;

FIG. 3 is a block diagram of a balanced multilayer coupled-line 180° hybrid coupler comprising four identical pairs of 90° directional couplers and a pair of 180° phase shifters;

FIG. 4 is a block diagram of a balanced multilayer coupled-line 180° hybrid according to a first embodiment of the present invention;

FIG. 5 is a block diagram of a balanced multilayer coupled-line 180° hybrid coupler according to a second embodiment of the present invention;

FIG. 6 is a circuit schematic corresponding to the balanced coupled-line 180° hybrid coupler of FIG. 4;

FIG. 7A shows response plots from a circuit simulation of the balanced coupled-line 180° hybrid coupler of FIG. 4;

FIG. 7B shows phase response plots of the balanced coupled-line 180° hybrid coupler of FIG. 4;

FIG. 8 shows a block diagram of balanced 180° hybrid coupler according to a third embodiment of the present invention.

FIG. 9 is plan view of a balanced coupled-line 180° hybrid coupler according to a fourth embodiment of the present invention; and

FIG. 10 shows response plots from an electromagnetic circuit simulation of the balanced coupled-line 180° hybrid coupler of FIG. 9.

### DESCRIPTION OF PREFERRED EMBODIMENTS

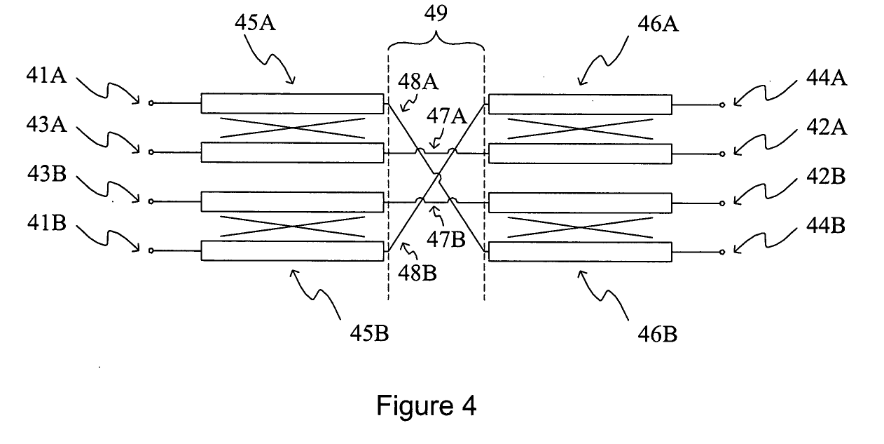

FIG. 3 shows a block diagram of a balanced 180° hybrid coupler where symbols 38A, 38B represent any element which provides a phase shift of 180°. The balanced hybrid coupler of FIG. 3 comprises four identical pairs of quarter wavelength parallel coupled lines, 35A, 35B and 36A, 36B. Balanced input ports 31A, 31B and 32A, 32B, and balanced output ports 33A, 33B and 34A, 34B are also provided.

For a balanced pair of signal carrying lines, the signals on the two lines are 180° out of phase relative to each other. Thus a phase shift of 180° can be realized on a balanced line by adding a twist along the line so that the positive phase signal carrying line is connected to the negative phase signal carrying line and vice versa.

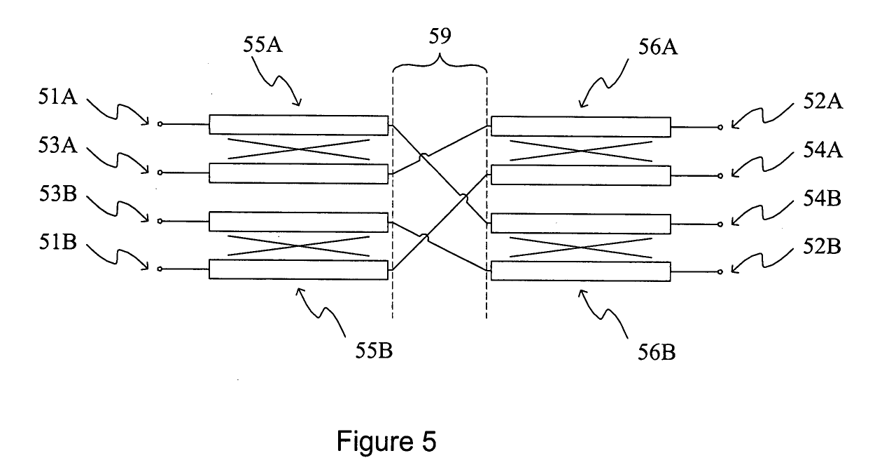

FIG. 4 shows a block diagram of balanced 180° hybrid coupler according to a first embodiment of the present invention. The balanced hybrid coupler of FIG. 4 comprises four identical pairs of quarter wavelength parallel coupled lines, 45A, 45B and 46A, 46B. The first input port of the balanced hybrid coupler of FIG. 4 comprises a pair of signal carrying terminals 41A, 41B, the second input port comprises the signal carrying terminals 42A, 42B, the first output port comprises signal carrying terminals 43A, 43B, and the second output port comprises signal carrying terminals 44A, 44B. A wiring section 49 includes a balanced connection comprising connecting lines 47A, 47B and a balanced connection comprising connecting lines 48A, 48B; these balanced connections connect quarter wavelength coupled lines 45A and 45B to quarter wavelength coupled line pairs 46A and 46B. Thus, connection line 47A connects one of the pair of coupled lines 45A to one of the pair of coupled lines 46A, and connection line 47B connects one of the pair of coupled lines 45B to one of the pair of coupled lines 46B. A twist is added to the balanced connection comprising connecting lines 48A and 48B so that connecting line 48A connects one of the pair of coupled lines 45A to one of the pair of coupled lines 46B and so that connecting line 48B connects one of the pair of coupled lines 45B to one of the pair of coupled lines 46A. The twist in the balanced connection comprising connecting line 48A and 48B produces the required phase shift of 180°. The balanced 180° hybrid coupler of FIG. 4 is compact due to the fact that the 180° phase shifting elements shown as 38A and 38B of FIG. 3 have been omitted.

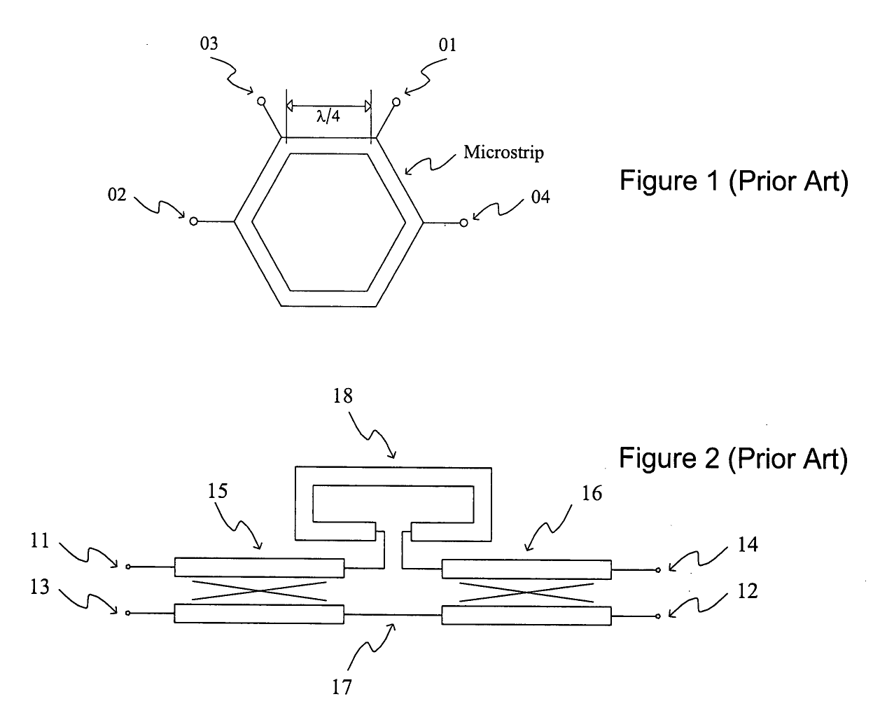

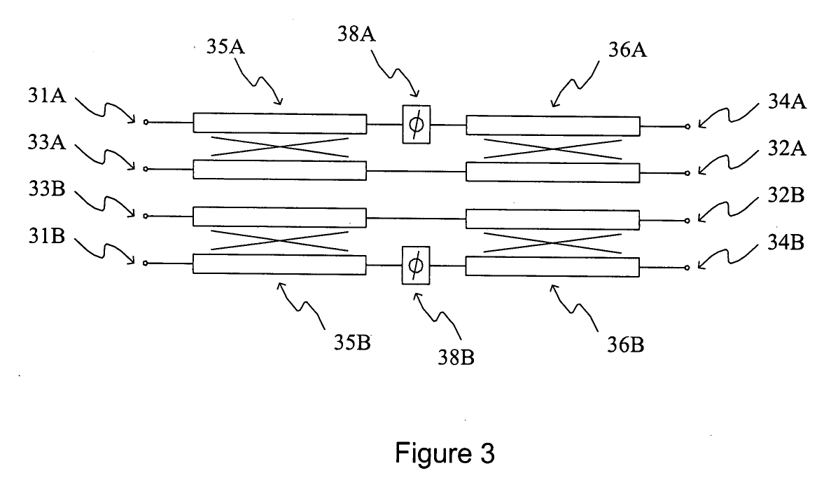

As for the single-ended hybrid couplers of FIG. 1A and FIG. 1B, the input and output ports of the balanced hybrid coupler of FIG. 4 can be interchanged to provide the same functionality.

Due to the symmetry of the electrical characteristics of a pair of parallel coupled lines, for each pair of quarter wavelength coupled lines 45A, 45B, 46A and 46B of FIG. 4, there is a choice of two orientations. In graphical terms, each pair of coupled lines 45A, 45B, 46A and 46B of FIG. 4 can be mirrored about a horizontal axis. Consequently, there up to 16 alternative orientations of the circuit of FIG. 4 which will provide approximately the same electrical characteristics; each of these 16 alternatives can be derived by mirroring the orientation of one or more of the coupled lines 45A, 45B, 46A, and 46B and retaining the corresponding input or output port connections to the ends of the coupled lines. The benefit of this feature of the present invention is that input and output ports may be placed strategically as demanded by the application in question.

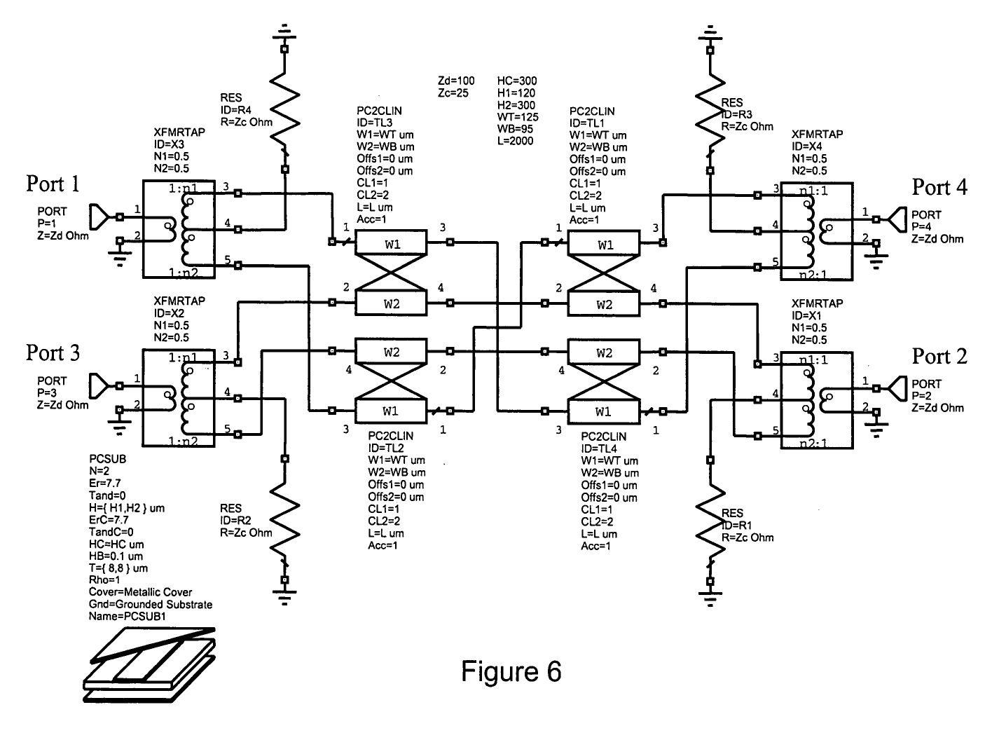

FIG. 5 shows a block diagram of balanced 180° hybrid coupler according to a second embodiment of the present invention. As before, the balanced hybrid coupler of FIG. 5 comprises four identical pairs of quarter wavelength parallel coupled lines, 55A, 55B and 56A, 56B, first and second input ports each comprising a pair of signal carrying terminals 51A, 51B, and 52A, 52B, first and second output ports comprising signal carrying terminals 53A, 53B, and 54A, 54B and a wiring section 59 which provides the connections between quarter wavelength parallel coupled lines, 55A, 55B and 56A, 56B. In FIG. 5, both pairs of quarter wavelength parallel coupled lines 56A, 56B has had its orientation mirrored about its long axis compared with the hybrid coupler of FIG. 4. The balanced 180° hybrid coupler of FIG. 5 might be selected for an application of a hybrid coupler requiring all inputs to fall on one layer, and all outputs to fall on a different layer of the same multilayer substrate.

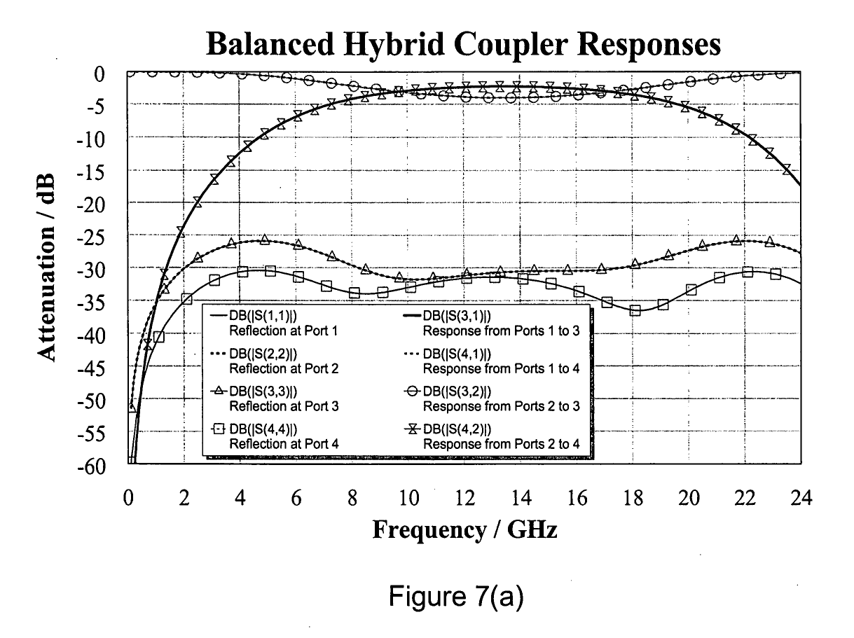

FIG. 6 shows a circuit schematic created using a computer based electric circuit simulation software package. The circuit schematic in FIG. 6 corresponds to the block diagram of a balanced 180° hybrid coupler of the first embodiment of the present invention as depicted in FIG. 4. The circuit schematic of FIG. 6 comprises 4 differential ports, labeled Port 1, Port 2, Port 3, Port 4, where, in line with FIG. 4, the input ports are selected as Port 1 and Port 2, and where the output ports are selected as Port 3 and Port 4. The circuit schematic further comprises 4 transformers which are used to generate the differential responses of the circuit, four pairs of parallel coupled lines, and various connections between the coupled lines and each other and between the coupled lines and the ports. The coupled lines are fabricated on the top and bottom surfaces of a layer of insulating dielectric substrate with a thickness of 120 mm and a relative permittivity of 7.7. The widths of the lines fabricated on the top surface of the insulating dielectric layer are 125 mm, and the widths of the lines fabricated on the bottom surface of the insulating dielectric layer are 95 um; each of the lines has a length of 2000 um. The insulating dielectric substrate is sandwiched between two further layers of the same material each with a thickness of 300 mm, and ground planes are added on the top and bottom of the dielectric sandwich.

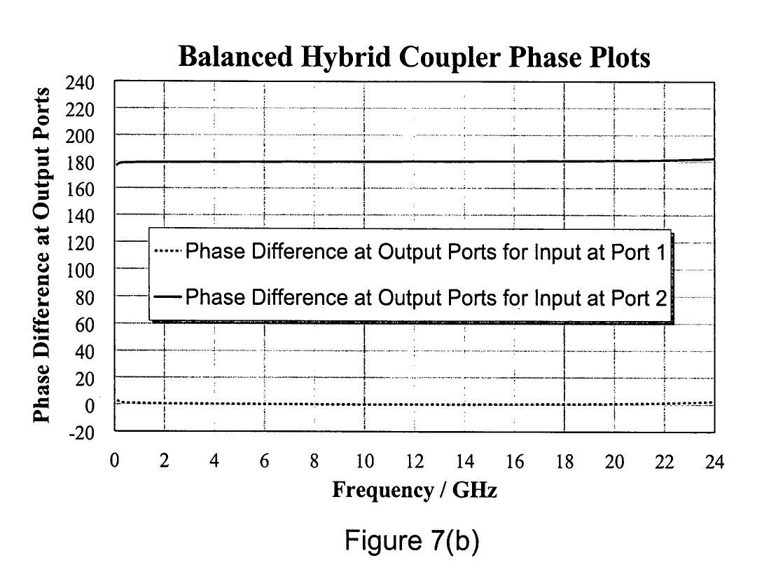

FIG. 7A shows various response plots of the circuit of FIG. 6 which were generated by the same circuit simulation software package used to create the schematic of FIG. 6. The plots shows several responses of the circuit of FIG. 6 as follows:

the magnitude (in dB) of the differential reflection coefficient of the circuit at Port 1, Port 2, Port 3 and Port 4;

the magnitude (in dB) of the differential through response of the circuit the from Port 1 to Port 3;

the magnitude (in dB) of the differential through response of the circuit the from Port 1 to Port 4;

the magnitude (in dB) of the differential through response of the circuit the from Port 2 to Port 3;

the magnitude (in dB) of the differential through response of the circuit the from Port 2 to Port 4.

It can be seen from FIG. 7A that the simulated balanced hybrid coupler of FIG. 6 has a passband of approximately equal power splitting from an input port to both output ports extending over a range from 10 GHz to 18 GHz approximately with a centre frequency of 14 GHz approximately.

FIG. 7B shows various phase plots of the circuit of FIG. 6 which were generated by the same circuit simulation software package used to create the schematic of FIG. 6 as follows:

the phase difference (in degrees) of the differential through response of the circuit the from Port 1 to Port 3 compared with the differential through response of the circuit the from Port 1 to Port 4;

the phase difference (in degrees) of the differential through response of the circuit the from Port 2 to Port 3 compared with the differential through response of the circuit the from Port 2 to Port 4.

It can be seen from FIG. 7B that the simulated balanced coupler of FIG. 6 provides the required phase conditions over an extremely wide frequency range, i.e. from 0 GHz to 24 GHz.

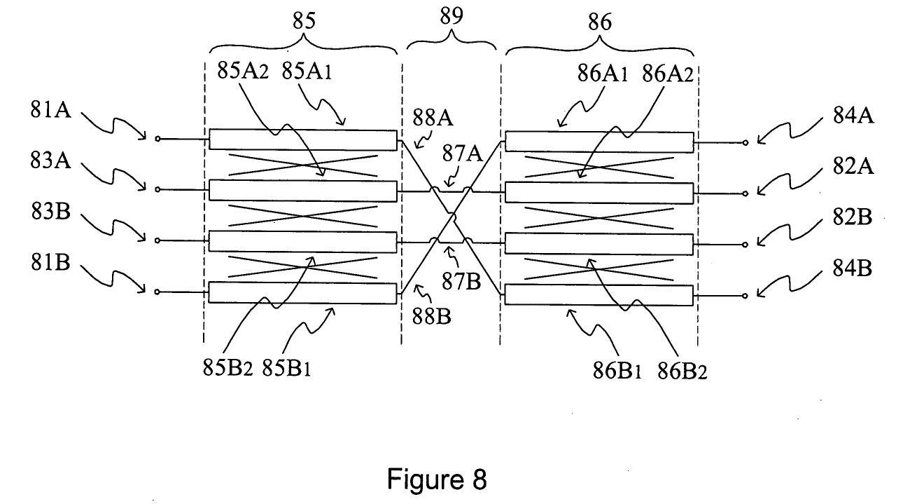

FIG. 8 shows a block diagram of balanced 180° hybrid coupler according to a third embodiment of the present invention. The balanced hybrid coupler of FIG. 8 comprises a first and a second set of four parallel coupled lines 85 and 86. First set of four parallel coupled lines 85 comprises constituent trace lines 85A1 85A2 85B1 and 85B2; second set of four parallel coupled lines 86 comprises constituent trace lines 86A1 86A2 86B1 and 86B2. Preferably, the coupling mechanism between four parallel coupled lines 85 is predominately broadside coupling between lines 85A1 and 85A2, predominately broadside coupling between lines 85B1 and 85B2, predominately edge coupling between lines 85A1 and 85B1 and, predominately edge coupling between lines 85A2 and 85B2. Preferably, the coupling mechanism between four parallel coupled lines 86 is predominately broadside coupling between lines 86A1 and 86A2, predominately broadside coupling between lines 86B1 and 86B2, predominately edge coupling between lines 86A₁ and 86B₁ and, predominately edge coupling between lines 86A₂ and 86B₂. The balanced 180° hybrid coupler of FIG. 8 includes first and second input ports each comprising a pair of signal carrying terminals 81A, 81B, and 82A, 82B, first and second output ports comprising signal carrying terminals 83A, 83B, and 84A, 84B and a wiring section 89 which provides the connections between first and second sets of four parallel coupled lines, 85 and 86.

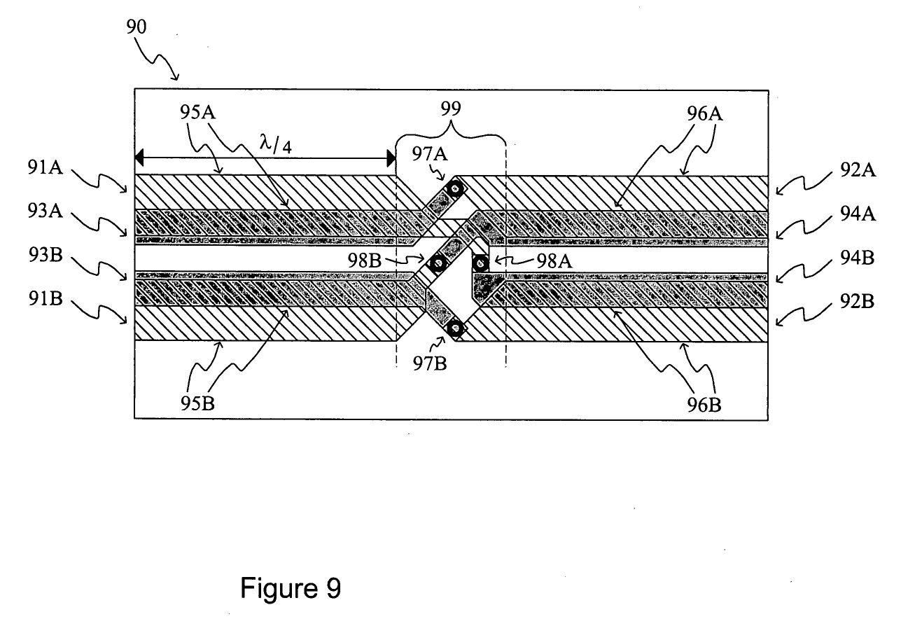

FIG. 9 shows a plan view of a 3D layout of a fourth embodiment of a balanced 180° hybrid coupler of the present invention. The balanced 180° hybrid coupler shown in FIG. 9 comprises 4 pairs of broadside coupled lines 95A, 95B, 96A and 96B. Each of the pairs of broadside coupled lines comprises a pair of constituent metal trace lines. The constituent trace lines of each coupled line pair are fabricated as conducting trace lines located on a lower side and on an upper side of an insulating substrate 90. The constituent trace lines are separated in a direction perpendicular to the plane of each line by a distance equal to the thickness of the intervening insulating layer. In FIG. 9 the lower side constituent trace lines of each of the coupled line pairs are identified by the solid grey patterns and the upper side constituent trace lines are represented by the hatched patterns. Electrical connections between coupled line pairs 95A, 95B, and 96A 96B are realized by electrically conducting plated through holes, which are typically referred to as vias, 97A, 97B, 98A, and 98B. The insulating substrate may be surrounded by air, or may be sandwiched between other layers of insulating material. Typically, the broadside coupled line pairs are located over a ground plane, or sandwiched between two ground planes; however, the separation between coupled line pairs and their one or more ground planes would normally be greater than the separation between the constituent trace lines of the coupled line pairs. In addition to the coupling mechanism between the constituent metal trace lines of broadside coupled line pairs 95A, 95B, 96A and 96B, some additional coupling exists between the constituent trace lines of 95A and those of 95B, similarly some coupling exists between the constituent trace lines of 96A and those of 96B. Thus, the equivalent circuit of the 3D layout of the balanced 180° hybrid coupler is most accurately represented by the block diagram shown in FIG. 8.

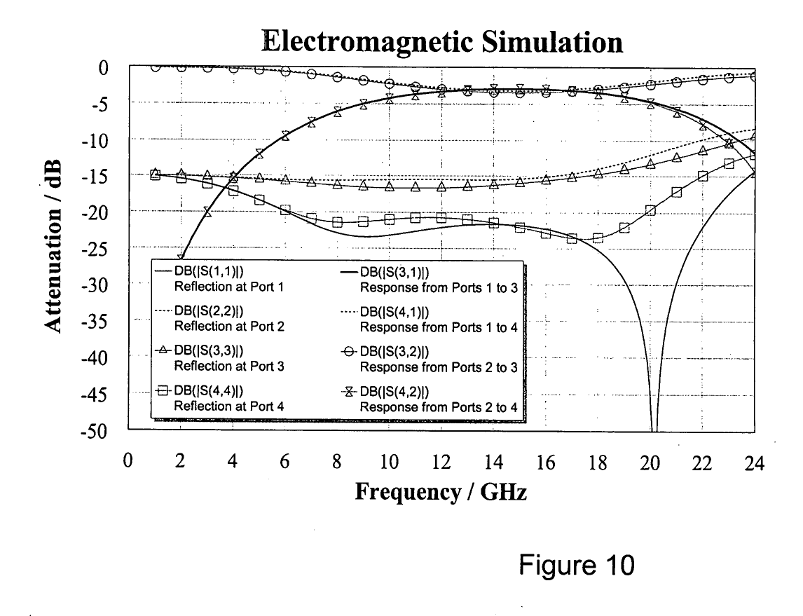

FIG. 10 shows various response plots generated by an electromagnetic simulation software package corresponding to the 3D layout of a preferred embodiment of the balanced 180° degrees hybrid coupler of present invention shown in FIG. 9. The plots shows several responses of the hybrid coupler as follows:

the magnitude (in dB) of the differential reflection coefficient of the circuit at port 1 (91A, 91B), port 2 (92A, 92B), port 3 (93A, 93B) and port 4 (94A, 94B);

the magnitude (in dB) of the differential through response of the circuit the from port 1 to port 3;

the magnitude (in dB) of the differential through response of the circuit the from port 1 to port 4;

the magnitude (in dB) of the differential through response of the circuit the from port 2 to port 3;

the magnitude (in dB) of the differential through response of the circuit the from port 2 to port 4.

It can be seen that the response plots generated by the electromagnetic simulation software package shown in FIG. 10 bear a close resemblance to the response plots shown in FIG. 7A which were generated by a circuit simulation software package applied to the block diagram of the balanced 180° degrees hybrid coupler of present invention shown in FIG. 4.

1. A balanced 180° hybrid coupler having an operating frequency band and a centre frequency of operation, said coupler comprising:
first, second, third and fourth pairs of parallel electrically coupled lines, each of said first, second, third and fourth pairs of parallel electrically coupled lines comprising a first and a second conducting trace line which, in use, are electrically coupled to each other, the electrical length of said first, second, third and fourth pairs of parallel coupled lines being one of quarter the wavelength of the centre frequency of operation of said balanced 180° hybrid coupler;
first, second, third and fourth balanced input/output (I/O) ports,
wherein a first of said trace lines of said first pair of parallel electrically coupled lines is connected to a positive phase terminal of said first balanced I/O port and a second of said trace lines of said first pair of parallel electrically coupled lines is connected to a positive phase terminal of said third balanced I/O port,
wherein a first of said trace lines of said second pair of parallel electrically coupled lines is connected to a positive phase terminal of said second balanced I/O port and a second of said trace lines of said second pair of parallel electrically coupled lines is connected to a positive phase terminal of said fourth balanced I/O port,
wherein a first of said trace lines of said third pair of parallel electrically coupled lines is connected to a negative phase terminal of said first balanced I/O port and a second of said trace lines of said third pair of parallel electrically coupled lines is connected to negative phase terminal of said third balanced I/O port,
wherein a first of said trace lines of said fourth pair of parallel electrically coupled lines is connected to a negative phase terminal of said second balanced I/O port and a second of said trace lines of said fourth pair of parallel electrically coupled lines is connected to a negative phase terminal of said fourth balanced I/O port, and
a wiring section, wherein said wiring section connects:
said first trace line of said first pair of parallel electrically coupled lines to said first trace line of said fourth pair of parallel electrically coupled lines and said second trace line of said first pair of parallel electrically coupled lines to said second trace line of said second pair of parallel electrically coupled lines;
and said first trace line of said third pair of parallel electrically coupled lines to said first trace line of said second pair of parallel electrically coupled lines and said second trace line of said third pair of parallel electrically coupled lines to said second trace line of said fourth pair of parallel electrically coupled lines.

2. The balanced 180° hybrid coupler of claim 1, wherein at least one of said trace lines of said first, second, third or fourth pair of parallel electrically coupled lines, when in use, is electrically coupled to at least one of said trace lines of another of said first, second, third or fourth pair of parallel electrically coupled lines.

3. The balanced 180° hybrid coupler of claim 1, comprising an insulating substrate and wherein said trace lines of said first, second, third or fourth pair of parallel electrically coupled lines are fabricated on the opposing planar surfaces of said insulating substrate.

4. The balanced 180° hybrid coupler of claim 3, further comprising one or more ground planes located at least above or below said planar surfaces of said insulating substrate.

5. The balanced 180° hybrid coupler of claim 1, comprising an insulating substrate and wherein said trace lines of said first, second, third or fourth pair of parallel electrically coupled lines are fabricated on the same planar surface of said insulating substrate.

6. The balanced 180° hybrid coupler of claim 5, further comprising one or more ground planes located above or below said planar surfaces of said insulating substrate.

7. The balanced 180° hybrid coupler of claim 1, comprising a multilayer insulating substrate and wherein said trace lines of said first, second, third or fourth pair of parallel electrically coupled lines are fabricated on one or more planar surfaces of said multilayer insulating substrate.

8. The balanced 180° hybrid coupler of claim 7, further comprising one or more ground planes located at least above or below said planar surfaces of said multilayer insulating substrate.

9. The balanced 180° hybrid coupler of claim 3, wherein said trace lines of said first, second, third or fourth pair of parallel electrically coupled lines are located in register with each other on said opposing planar surfaces of said insulating substrate.

10. The balanced 180° hybrid coupler of claim 1, wherein the coupling ratio between said first and second conducting trace lines of said first, second, third and fourth pairs of parallel electrically coupled lines is −7.67 dB.
